(19) United States
(12) Patent Application Publication
(10) Pub. No.: US 2010/0300807 A1
(43) Pub. Date: Dec. 2, 2010

(54) Half step

(76) Inventor: Adam Scott Lindsey, Escondido, CA (US)

Correspondence Address: Adam Lindsey, 2135 E. Valley Pkwy. #11, Escondido, CA, 92027, US

(21) Appl. No.: 12/454,858

(22) Filed: May 27, 2009

(51) Int. Cl. E06C 7/00

(52) U.S. Cl. 182/129

(57) ABSTRACT

‘The Half Step’ provides new working heights for ladders approximately half way between the existing rungs of a ladder and will hopefully improve the lives, backs, necks and shoulders of anyone who has ever had to or ever will have to work from a ladder at an awkward position because the rungs of existing ladders are so far apart.

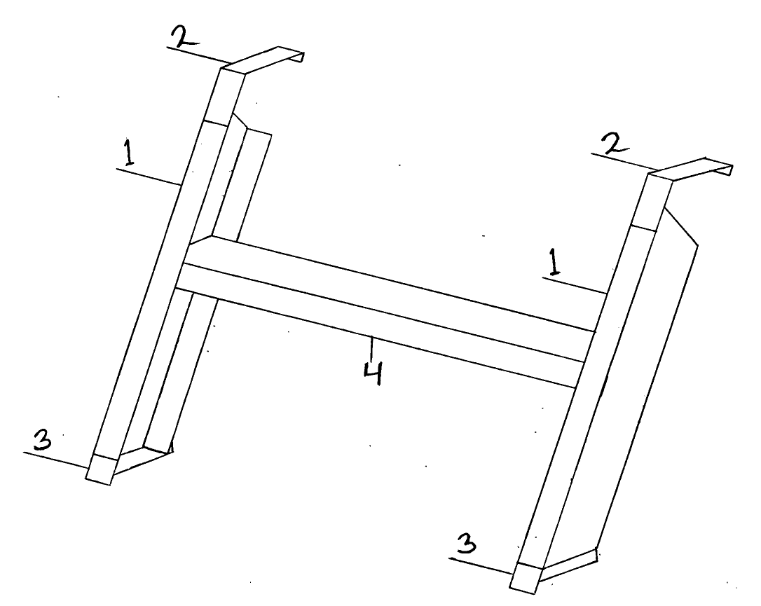

The title of the invention is ‘The Half Step’. Adam Lindsey is the only applicant, he is a citizen of the USA and his residence is 2135 E. Valley Pkwy. #11, Escondido, Calif., 92027.

### CROSS-REFERENCE TO RELATED APPLICATIONS

Adam Lindsey conducted his own patent search and hired UPR LTD to conduct a patent search and no related product or application was found.

### STATEMENT REGARDING FEDERALLY SPONSORED RESEARCH OR DEVELOPMENT

Not Applicable

### REFERENCE TO SEQUENCE LISTING, A TABLE, OR A COMPUTER LISTING COMPACT DISC APPENDIX

Not Applicable

### BACKGROUND OF THE INVENTION

‘The Half Step’ pertains to and is for use with ladders. Ladder rungs are approximately one foot apart and in some situations a comfortable working height cannot be achieved. ‘The Half Step’ will provide a significant solution to this problem. There are no specific documents known to me that are related to my invention.

### BRIEF SUMMARY OF THE INVENTION

Many times while working from a ladder, especially in an area with a soffit or a drop ceiling, you can't always position your ladder exactly where you need it. On one rung it feels as if you're reaching for your work but when you take a step up on your ladder your head has to be crooked to the side because there is an obstruction directly above you or your face is inches away from your work. ‘The Half Step’ cuts the distance between two ladder rungs in half and enables you to work in a more ergonomic position which is important when you may be repeating the process repeatedly over an eight hour work day

### BRIEF DESCRIPTION OF THE SEVERAL VIEWS OF THE DRAWING

I have included one perspective drawing of the ‘The Half Step’. The features of ‘The Half Step’ have been numbered and can be referenced with the Detailed Description of the Invention.

### DETAILED DESCRIPTION OF THE INVENTION

‘The Half Step’ is comprised of two vertical runners 1 that parallel each other. Fastened at the top of each runner there is a clip 2, that hangs from a rung of a ladder. Fastened at the bottom of each runner there is a retaining foot 3 that rests on the rung of the ladder just below the rung that the clips hang from. Approximately half way between the clips at the top of the runners and the feet at the bottom of the runners there is a horizontal rung 4 fastened to the two vertical runners.

To use ‘The Half Step’ you simply place it between any two rungs of the ladder, with the clips on top and feet on the bottom. Once you've decided where to place ‘The Half Step’ you continue working from the ladder as you normally would. When ‘The Half Step’ is not being used it can be stored on the ladder and simply stepped past as if it weren't there.

‘The Half Step’ could be manufactured using a wide variety of materials, that are of appropriate strength, on machinery already in use by ladder manufactures today.

1. The Half Step’ provides you with a working platform half way between any two rungs of a ladder (except the top two for safety) that didn't exist before.
